(19) United States
(12) Patent Application Publication
(10) Pub. No.: US 2013/0233424 A1
(43) Pub. Date: Sep. 12, 2013

(54) LIQUID DISTRIBUTOR OF MODULAR CONSTRUCTION

(71) Applicants: Markus FREY, Eppingen (DE); Axel GERLACH, Eppingen-Kleingartach (DE); Thomas HEINZ, Zaberfeld (DE); Thomas VON OLNHAUSEN, Eppingen-Kleingartach (DE)

(72) Inventors: Markus FREY, Eppingen (DE); Axel GERLACH, Eppingen-Kleingartach (DE); Thomas HEINZ, Zaberfeld (DE); Thomas VON OLNHAUSEN, Eppingen-Kleingartach (DE)

(21) Appl. No.: 13/756,440

(22) Filed: Jan. 31, 2013

(30) Foreign Application Priority Data
Mar. 6, 2012 (EP) 12 158 270.4

(51) Int. Cl. F17D 1/08

(52) U.S. Cl. CPC F17D 1/084
USPC 137/627

(57) ABSTRACT

A geothermal plant brine distributor includes a plurality of distributor modules which are detachably connected to each other and are arranged in series behind one another forming a continuous main line. A connector module is connectable to a distributor supply line or distributor return line and also to the distributor modules. Each distributor module includes a housing of plastic material including a main line section, each end of which is surrounded by one connector flange, a pipe-shaped valve stem which branches off from the lateral surface side of the main line section and has a side opening, and a branch pipe that joins the side opening of the valve stem. A hollow cylinder valve body is rotatable in the valve stem for closing or opening fluid flow from the main line to the branch pipe.

### CROSS-REFERENCE TO RELATED APPLICATIONS

This application claims priority under 35 U.S.C. §119(a) to European Patent Application No. 12158270.4, filed Mar. 6, 2012, the entire contents of which are hereby incorporated by reference.

### DESCRIPTION

1. Field of the Invention

The present invention relates to a liquid distributor. More particularly, the present invention relates to a brine distributor for geothermal plants.

2. Background of the Invention

Energy saving measures for the heating of buildings are becoming more and more important and for this reason, geothermics is also becoming more important. Liquid distributors which are produced from extruded pipes and require correspondingly complex finishing work are conventionally used for large plants. For distributors of this type, thick-walled pipes are cut to the required length, bores are provided for the probe circuits (brine circuits) and the corresponding connectors are welded or mounted to each probe circuit. The required stop valves and control valves as well as the flow indicators are mounted as downstream valves to such a distributor. This method is advantageous in that the common distance dimensions for the probe outlets can be easily realized. However, the large amount of time and expense that is required is disadvantageous, since each liquid distributor represents a one-off production and is generally also produced order-related. For this reason, longer delivery times are unavoidable. With an increasing number of probe circuits, the distributors can have a length of up to several meters, causing problems with respect to transport and storage.

In some cases industrially produced liquid distributors of plastic material are used for smaller geothermal plants. DE 10 2005 008 833 A1 discloses such a distributor, wherein individual distributor segments are produced, are provided with end pieces and connecting pieces and are assembled using drawbars. WO 99/001701 A1 also discloses a distributor, wherein the individual distributor segments are connected to each other via an integrated special thread. However, distributors according to these two systems are suitable only to a limited extent for the requirements in geothermal applications since the dimensions of the flow cross-sections of the distributor and of the valves are not sufficient or cannot be made sufficient. The reason therefore is the valves that extend up to the center of the flow cross-section of the distributor.

It is the object of the present invention to specify a liquid distributor of modular construction, which can be configured and assembled as easily as possible. The present invention fulfills these needs and provides other related advantages.

### SUMMARY OF THE INVENTION

This object is achieved in accordance with the invention by a liquid distributor according to claim 1.

The inventive modular construction permits industrial prefabrication of corresponding distributor kits such that only final adjustment to the local conditions on the building site is required. This means that the required modules are connected to one another and the final assembly of the distributor is carried out on the building site.

The modular construction permits production of fixed lengths of the distributor, which are determined by the manufacturer (e.g. strings with 6 brine circuits), to ensure quick final assembly on site. For example, 2 module strings each having 6 brine circuits and 2 individual modules are assembled on the building site for a distributor having 14 brine circuits. All components can thereby be stored and transported on commercially available europallets. The modular construction enables easy storage of the modular components for final assembly of the distributors at the retailers or specialist companies.

In particular, the inventive modular liquid distributor offers the following advantages:
modularity;
industrially prefabricated and tested for tightness;
short-term availability since it can be individually assembled;
probe outlets can be arbitrarily positioned (can be rotated through 0-360° and turned about the distributor axis);
minimum probe separations can be realized;
different probe separations can be realized by means of spacers;
distributor can be mounted across the corner and be brought into an approximately round shape;
identical probe separations also when the outlets are rotated;
integrated flow control valves with large Kvs-values;
free flow cross-section by tangentially linked valve technology, i.e. no narrowing of the cross-section by valves which are usually in the center area of the distributor. This achieves a high volume flow or a large Kvs-value;
integrated flow indicator;
orifice plates for hydraulic balance, which can be integrated;
temperature indicator which can be integrated; and
modular connector system for probe connectors in which different probe pipes can be connected using a distributor through selection of a pipe adapter.

Further advantages and advantageous embodiments of the subject matter of the invention can be extracted from the description, the drawing and the claims. The features mentioned above and below may be used individually or collectively in arbitrary combination. The illustrated and described embodiments are not to be understood as an exhaustive enumeration but have exemplary character for describing the invention.

### BRIEF DESCRIPTION OF THE DRAWINGS

The accompanying drawings illustrate the invention. In such drawings:

FIGS. 1a-1c show an inventive upper brine distributor, which is arranged in the supply line of a brine circuit, and an inventive lower brine distributor, which is arranged in the return line of the brine circuit, each having three distributor modules in a perspective view (FIG. 1a), in a front view (FIG. 1b) and in a longitudinal sectional view (FIG. 1c) in accordance with the intersecting line Ic-Ic in FIG. 1b;

FIGS. 2a-2c show achievable grid dimensions for distributor modules having the same width (FIG. 2a), for distributor modules having two different widths (FIG. 2b) and for distributor modules and distance modules having different widths (FIG. 2c);

FIG. 3 shows an inventive brine distributor with four distributor modules, one of which is turned with respect to the other distributor modules;

FIG. 4 shows an inventive brine distributor with six distributor modules which are arranged across the corner;

FIGS. 5a, 5b each show a longitudinal sectional view of a distributor module with completely opened valve (FIG. 5a) and with closed valve (FIG. 5b);

FIG. 6 shows a distributor module with connectors for hydraulic flow balance; and

FIGS. 7a, 7b show perspective views of the module housing shown in FIGS. 5 and 6 with an axially displaceable stop ring in its non-rotatable front position (FIG. 7a) and in its rotatable rear position (FIG. 7b).

### DETAILED DESCRIPTION OF THE PREFERRED EMBODIMENTS

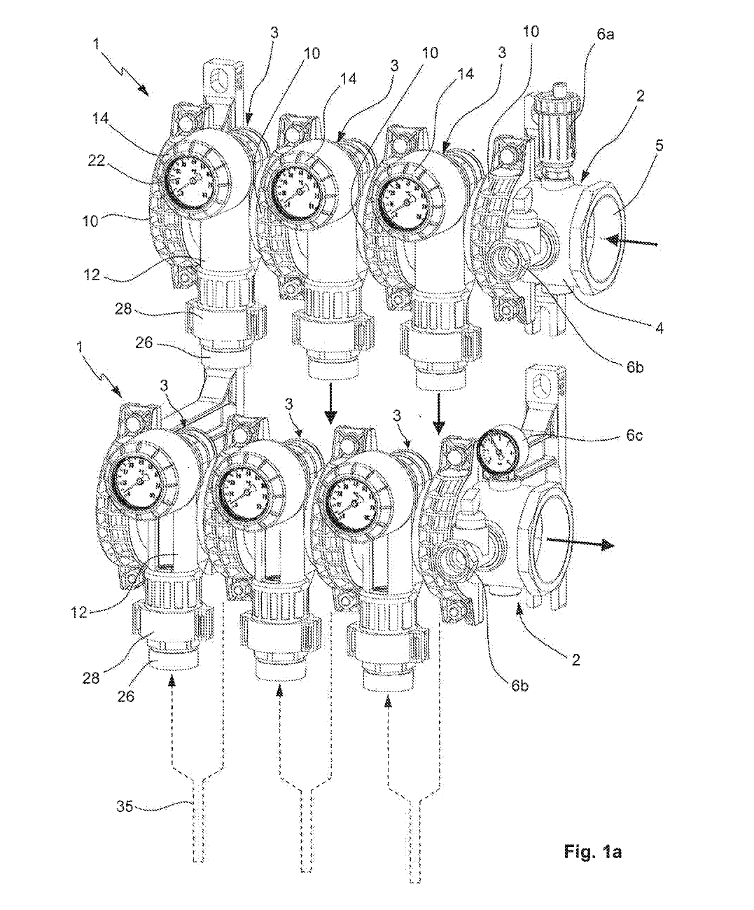

FIGS. 1a-1c show two identically constructed brine distributors 1 of a geothermal plant, the upper one of which is arranged in the supply line and the lower one of which is arranged in the return line of the brine circuits 35. Each brine distributor 1 is assembled from four modules 2, 3, which are detachably connected to each other and are arranged in series behind one another. As shown in FIG. 1, the modules are assembled from the right-hand side to the left-hand side, from a connector module 2 for connection to a distributor supply line or distributor return line and to three distributor modules 3.

The connector module 2 has a one-piece module housing 4 of plastic material having a main line section 5, one end of which is surrounded by a circular connector flange (not shown). The connector module 2 is moreover provided with the required fittings 6a-6c for filling, pressure indication, deaeration and rinsing. For example, the brine circuits 35 can be geothermal probes which extend to a depth of up to 100 m, surface collectors which are provided at a depth of 1-2 m, or probe cages which are helically wound and are provided at a depth of 1-2 m.

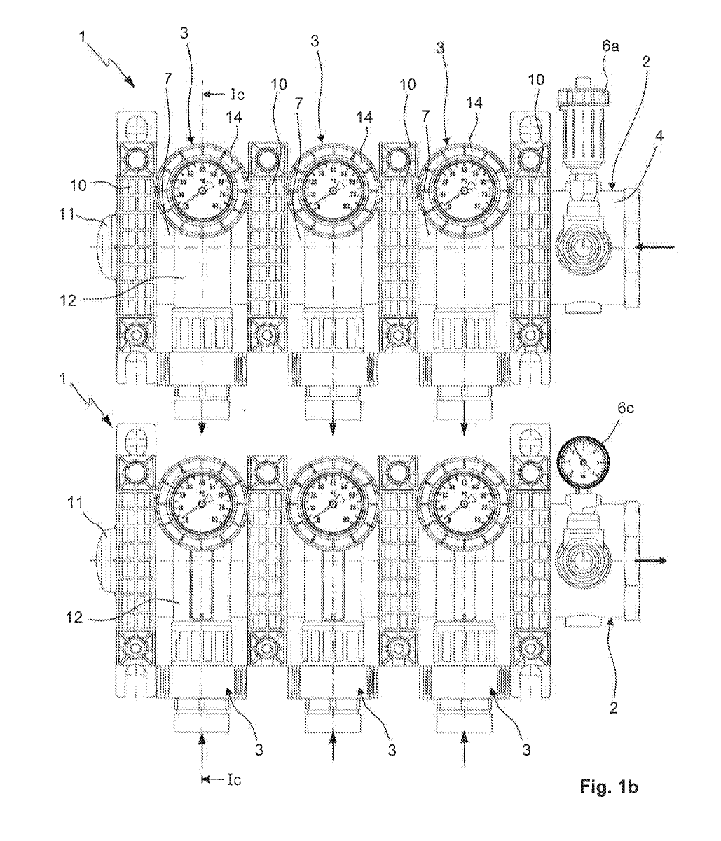

The distributor modules 3 have the same construction and comprise a one-piece module housing 7 of plastic material with a main line section 8 (FIG. 1c), which is surrounded at both ends by a circular connector flange 9 (FIG. 2). The connector flanges 9 of neighboring modules 2, 3 abut one another and are each clamped to one another with force fit using pipe clamps 10. The main line sections 5, 8 of the modules 2, 3 form a continuous main line in the brine distributor 1. The main line section 8 of the distributor module 3 on the left-hand side in FIG. 1 is closed by a blind flange 11 (FIG. 1b) which is clamped on the connector flange 9 of the distributor module 3 also by means of a pipe clamp 10. As is described in more detail below, one branch pipe 12 of each brine circuit 35 branches off from the main line section 8 of the distributor modules 3. A valve 13 with a handwheel 14 is arranged between the main line section 8 and the branch pipe 12 for shutting-off and controlling the flow rate.

As is indicated in FIG. 1 by flow arrows, the water flows centrally into the upper brine distributor 1 via the connector module 2 and flows further into the three distributor modules 3 which distribute the water to the individual brine circuits 35 via their branch pipes 12. The water from the individual brine circuits 35 flows via the branch pipes 12 into the three distributor modules 3 of the lower brine distributor 1 and from there centrally out of the connector module 2 of the lower brine distributor 1.

As is indicated in FIG. 1c, the pipe clamp is formed by two clamp halves 10a, 10b, wherein the rear clamp half 10b is simultaneously designed as a wall holder. FIG. 1c also shows that each branch pipe 12 of the upper brine distributor 1 is integrally formed by a pipe section of the module housing 7 and each branch pipe 12 of the lower brine distributor 1 is formed by a sealed separate pipe insert.

FIGS. 2a-2c show the achievable grid dimensions for distributor modules 3 having a width of 100 mm (FIG. 2a), for two distributor modules 3 of a width of 80 mm and 100 mm, and for distributor modules 3 of a width of 80 mm and 100 mm and additional distance modules 15 made from plastic material of a width of 30 mm. In the latter case one can realize e.g. a total of 6 distance dimensions (80/90/100/110/120/130 mm). Each distance module 13 has a main line section (not shown) with two circular connector flanges 9 which are provided at the ends and are connected to the connector flanges of the distributor modules 3 via pipe clamps 10. As is illustrated in FIGS. 2b, 2c, neighboring modules 3, 13 are sealed by an intermediate sleeve or distance sleeve 16 which is inserted into their main line sections 8.

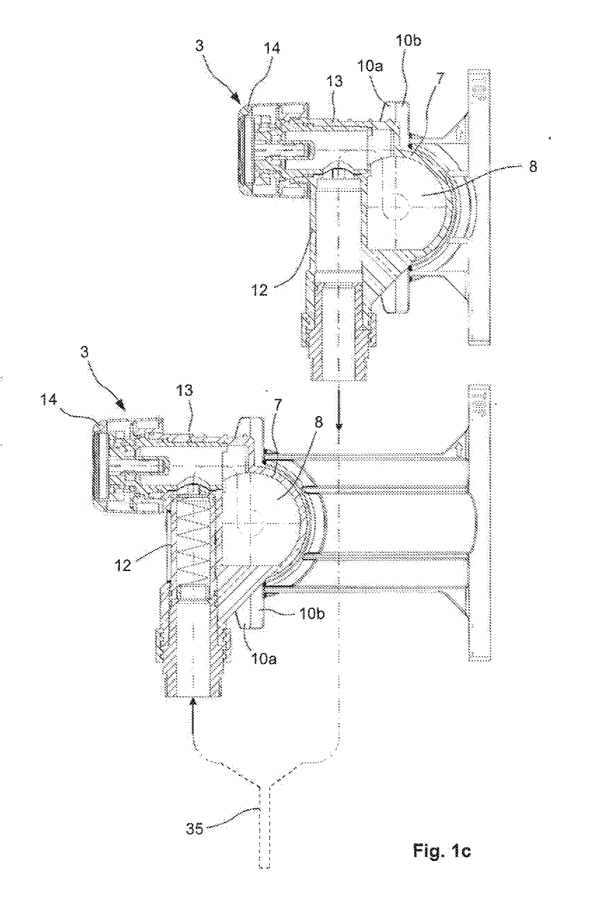

The circular connector flanges 9 allow rotating of individual distributor modules 3 into the desired connecting direction of the probe. FIG. 3 shows four identically constructed distributor modules 3a-3d, of which the second to the left distributor module 3b is rotated through approximately 45° about the horizontal module axis with respect to its two neighboring distributor modules 3a, 3c. The distributor module 3d on the right-hand side is arranged being turned, i.e. rotated through 180° about the vertical module axis, and its branch pipe 12 is aligned towards the top such that the handwheel 14 faces again in a forward direction.

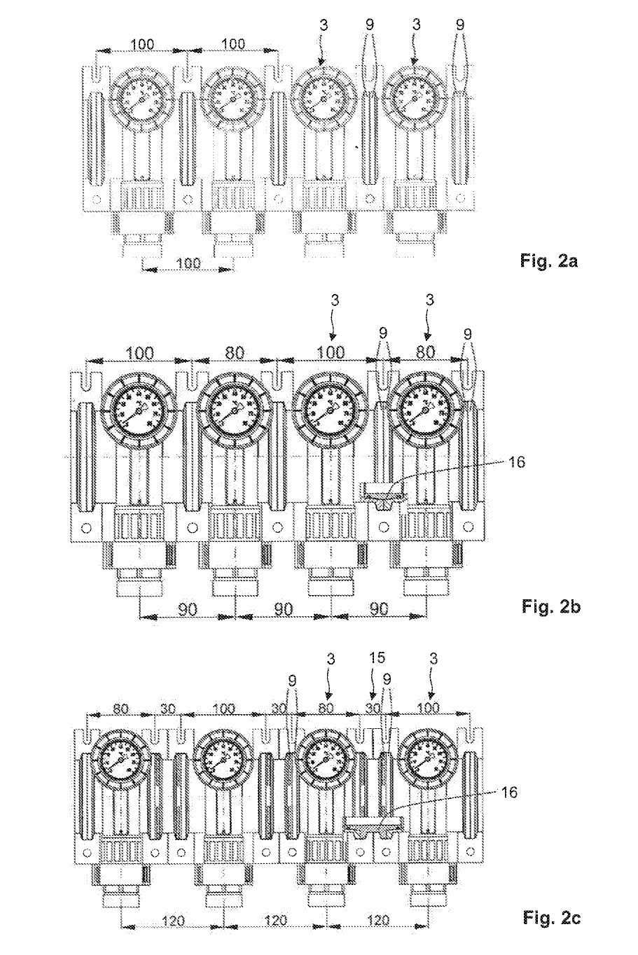

FIG. 4 shows a brine distributor 1 with a connector module 2 and six distributor modules 3, which are arranged across the corner using a 90° angle module of plastic material. The angle module 17 has a main line section with two circular connector flanges which are provided at the ends and are connected to connector flanges 9 of the distributor or distance modules 3, 15 by means of pipe clamps 10. For example, several angle modules 17 of this type render possible a brine distributor having a U shape which can be introduced into and mounted to a round brine shaft.

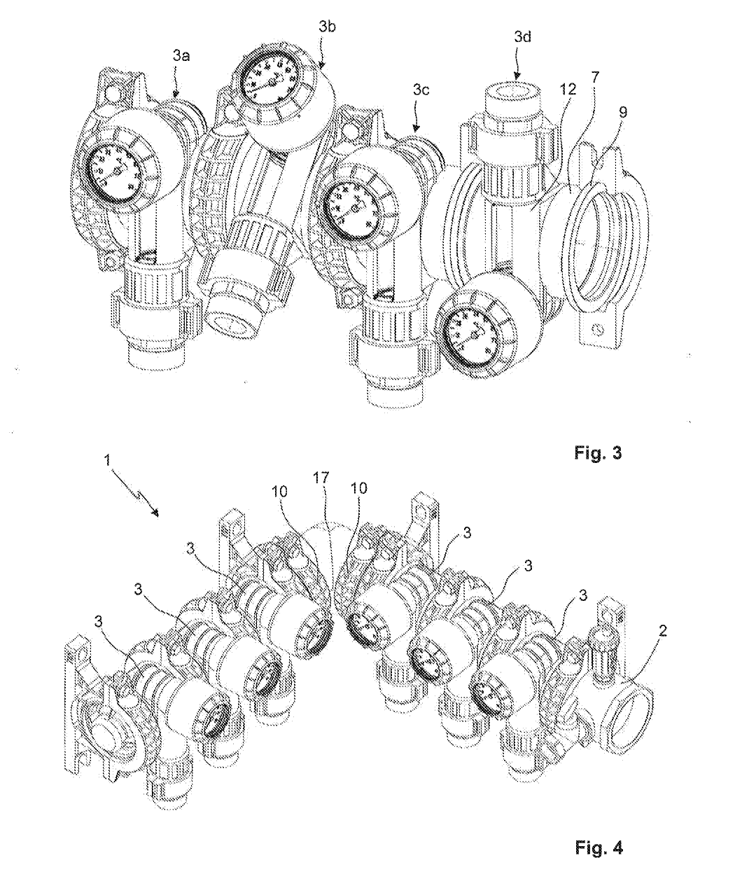

As is illustrated in FIGS. 5a, 5b, a pipe-shaped valve stem 18 projects from the module housing 7 of the distributor module 3 to the outside, the valve stem 18 extending from the lateral surface of the main line section 8 and comprising a side opening 19. A valve body in the form of a hollow cylinder 20 that is open towards the main line section 8 is inserted from the outside into the valve stem 18 and is disposed therein such that it can be rotated. The hollow cylinder 20 comprises a valve opening 21 on its lateral surface for closing or opening the side opening 19 of the valve stem 18 and is rotated via the handwheel 14. The hollow cylinder 20 can have a second softer plastic component on its outer side in order to improve the sealing effect. In this way, the valve 13 can be fully opened e.g. by approximately a half-turning, or can be correspondingly adjusted to an intermediate position. The valve 13 is illustrated in FIG. 5a in a completely open state and in FIG. 5b in a closed state. The valve 13 does not engage the main line section 8 but is laterally integrated on the module housing 7 to enable maintenance of a maximum size flow cross-section in the main line section 8 and minimize the associated pressure loss. A thermometer 22 is installed in the handwheel 14 of the valve 13 and displays the corresponding brine temperature.

The branch pipe 12 in the form of a separate pipe insert, which is inserted into a plug connector 23 provided on the outside of the module housing 7, joins the side opening 19 of the valve stem 18. The branch pipe 12 is designed in the form of a flow meter with a displaceably guided sleeve 24 which is pushed against the spring 25 by the liquid flowing in the direction of the arrow and is visible from the outside through the transparent pipe wall of the pipe insert and a slot 23a of the plug connector 23. For mounting the actual probe pipe (not shown), the branch pipe 12 is extended within the plug connector 23 by an adapter pipe 26 of plastic material or metal, the free end of which has a screw thread or a weld end 27. The adapter pipe 26 is held on the pipe connector 23 by means of a pipe clamp 28.

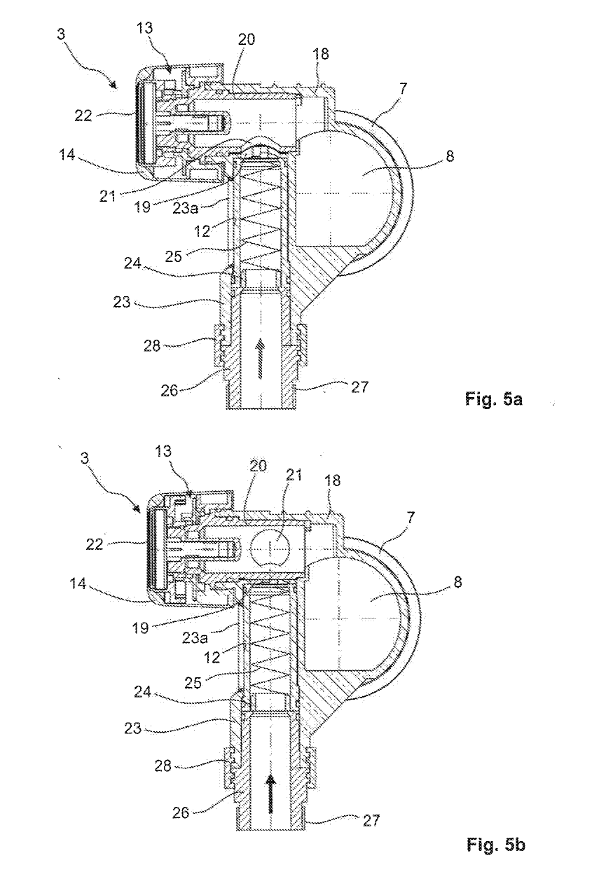

In FIG. 1, the branch pipes 12 of the upper brine distributor 1 are designed as integral pipe sections of the module housing 7 and the branch pipes 12 of the lower brine distributor 1 are designed as separate pipe inserts with flow meters. In the latter case, the adapter pipe 26 is inserted into the branch pipe 12 and is held thereon via a pipe clamp 28. As is illustrated in FIG. 6, the separate pipe insert 12 can alternatively also be designed as an orifice plate 29 with two measurement connections 30 for hydraulic balance.

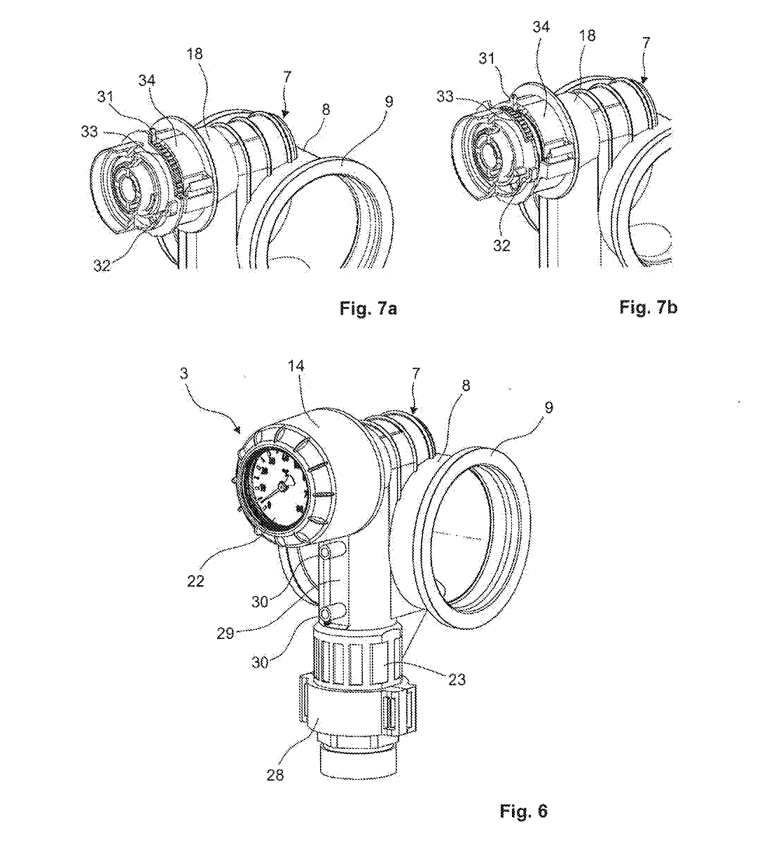

As is illustrated in FIGS. 7a, 7b, a stop ring 31 is guided on the outside of the valve stem 18 such that it can be displaced between a front end position (FIG. 7a) and a rear end position (FIG. 7b), and limits rotation of the hollow cylinder 20 by means of a rotation stop 32. The stop ring 31 can be freely rotated in its rear end position on the valve stem 18 in order to thereby rotate the rotation stop 32 to the desired stop position, and is non-rotationally fixed on a toothed ring 33 of the valve stem 18 for co-rotation in its front end position to thereby fix the adjusted stop position. A two-part mounting ring 34 is also mounted to the valve stem 18 to secure the hollow cylinder 20 in the valve stem 18.

Instead of using pipe clamps as illustrated in the figures, the neighboring modules can also be connected in a different conventional manner, e.g. by a threaded joint.

Although several embodiments have been described in detail for purposes of illustration, various modifications may be made to each without departing from the scope and spirit of the invention. Accordingly, the invention is not to be limited, except as by the appended claims.

What is claimed is:

1. A liquid distributor, comprising:
a plurality of distributor modules which are detachably connected to each other and arranged in series adjacent to one another, each distributor module comprising:
a housing forming a main line section including two ends, each end surrounded by a connector flange;
a pipe-shaped valve stem branching off from a lateral surface side of the main line section in fluidic communication with the main line section through a side opening;
a valve comprising a valve body in the form of a hollow cylinder which is in open fluidic communication with the main line section through the side opening, the valve body insertable from an outside of the valve stem and rotatable within the valve stem, the valve body comprising a valve opening on its lateral surface for opening or closing fluidic communication to a branch pipe connected to the valve stem;
a connector module connectable at one end to a distributor supply line or a distributor return line and connected at the other end to a first end of the plurality of distributor modules;
a blind flange connected to a second end of the plurality of distributor modules; and
a connecting means for connecting two abutting connector flanges of the plurality of distributor modules, for connecting the connector module to the first end of the plurality of distributor modules, and for connecting the blind flange to the second end of the plurality of distributor modules;
wherein the main line sections of the plurality of distributor modules form a continuous main line.

2. A liquid distributor, in particular brine distributor for geothermal plants, comprising:
a plurality of distributor modules, which are detachably connected to each other, are arranged in series behind one another, form together a continuous main line and comprise a connector module for connection to a distributor supply line or a distributor return line and connection to the plurality of distributor modules; and
a connecting means for connecting two abutting circular connector flanges of two neighboring distributor modules, each distributor module comprising:
a distributor module housing of plastic material comprising a main line section, each end of which is surrounded by one connector flange;
a pipe-shaped valve stem which branches off from the lateral surface side of the main line section and has a side opening;
a branch pipe that joins the side opening of the valve stem; and
a valve with a valve body in the form of a hollow cylinder which is open towards the main line section, is inserted from the outside into the valve stem, is disposed therein in a rotatable manner and has on its lateral surface a valve opening for closing or opening the side opening of the valve stem.

3. The liquid distributor according to claim 2, including a plug connector provided on an outside of the branch pipe.

4. The liquid distributor according to claim 2, wherein two neighboring modules are sealed by a sealing sleeve which is inserted into the main line sections.

5. The liquid distributor according to claim 2, wherein the connecting means are formed by pipe clamps, each pipe clamp clamping two abutting connector flanges of two neighboring modules against each other.

6. The liquid distributor according to claim 5, wherein the pipe clamp comprises two clamp halves, one clamp half of which is formed as a wall holder.

7. The liquid distributor according to claim 2, wherein two distributor modules are connected to each other via a distance module of plastic material having a main line section with two circular connector flanges provided at the ends.

8. The liquid distributor according to claim 2, wherein two distributor modules are connected to each other via an angle module of plastic material having a main line section with two circular connector flanges provided at the ends.

9. The liquid distributor according to claim 3, wherein the branch pipe that is inserted into the plug connector is designed as a flow meter or an orifice plate with two measurement connections for hydraulic balance.

10. The liquid distributor according to claim 2, wherein the valve comprises a handwheel for rotating the hollow cylinder.

11. The liquid distributor according to claim 10, wherein a thermometer is installed in the handwheel of the valve.

12. The liquid distributor according to claim 2, wherein a stop ring, which limits rotation of the hollow cylinder, is guided on the valve stem such that it can be displaced between a first position, in which it is non-rotationally fixed on the valve stem, and a second position, in which it can be rotated on the valve stem.

13. The liquid distributor according to claim 2, wherein the connector module is provided with fittings, in particular for filling, pressure indication, deaeration or rinsing.
